(19) United States
(12) Patent Application Publication
(10) Pub. No.: US 2026/0359640 A1
(43) Pub. Date: Nov. 12, 2026

(54) UNIVERSAL EMBEDDING FOR SCALABLE ASSESSMENT

(71) Applicant: PayPal, Inc., San Jose, CA (US)

(72) Inventors: Shao-Hsuan Huang, Shanghai (CN); Xueqian Pan, Shanghai (CN); Jie Chen, Shanghai (CN); Xiuyi Ling, Shanghai (CN)

(21) Appl. No.: 19/232,063

(22) Filed: Jun. 9, 2025

(30) Foreign Application Priority Data
May 7, 2025 (WO) PCT/CN2025/093040

(51) Int. Cl. G06N 3/084; G06N 3/0464

(52) U.S. Cl. CPC G06N 3/084; G06N 3/0464

(57) ABSTRACT

Techniques are disclosed for training a student machine learning model using multiple parent machine learning models to generate universal embedding generation layers. A student model is trained via a distillation algorithm using outputs from parent models, with parent training layers facilitating the alignment of student model predictions to the parent models. After training, the parent training layers are discarded. The universal embedding generation layers are stored for reuse. These layers can be coupled with specialized layers to create specialized machine learning models tailored for different tasks. The trained models process input data using the universal embedding generation layers. Specialized layers refine the embedding to produce task-specific outputs. This approach enables knowledge transfer across machine learning tasks, improves model efficiency, and reduces the need for redundant training.

### PRIORITY CLAIM

The present application claims priority to PCT Appl. No. PCT/CN2025/093040, entitled “UNIVERSAL EMBEDDING FOR SCALABLE ASSESSMENT”, filed May 7, 2025, which is incorporated by reference herein in its entirety.

### BACKGROUND

### Technical Field

This disclosure relates generally to machine learning and, more specifically, to improving the efficiency of machine learning models across various tasks.

### Description of the Related Art

Machine learning (ML) models are widely used across various domains, including fraud detection, risk assessment, and identity verification. These models are typically trained for specific tasks, with each model learning its own task-specific embeddings to represent input data. In many cases, different machine learning models must be trained separately, requiring significant computational resources and training time. Additionally, when deploying models for new tasks, retraining from scratch is often necessary to adapt to the new requirements, leading to inefficiencies in model reuse and knowledge transfer. Traditional approaches to model training generally focus on task-specific learning, limiting their ability to generalize across multiple tasks while maintaining performance.

### BRIEF DESCRIPTION OF THE DRAWINGS

FIG. 1 is a block diagram illustrating a universal embedding generation system, according to some embodiments.

FIG. 2 is a block diagram illustrating a student model training process, according to some embodiments.

FIG. 3 is a block diagram illustrating a specialized machine model creation process, according to some embodiments.

FIG. 4 is a block diagram illustrating specialized machine model usage, according to some embodiments.

FIGS. 5A-C are flow diagrams illustrating embodiments of methods implementing techniques described herein.

FIG. 6 is a block diagram illustrating elements of an exemplary computer system for implementing techniques described herein.

### DETAILED DESCRIPTION

Traditional machine learning models are typically trained independently for specific tasks including, but not limited to, fraud detection, risk assessment, and identity verification. Each model generates its own embeddings (e.g., mathematical representations of input data) leading to inefficiencies when generalizing across different tasks. In knowledge distillation, a single student model is trained to replicate the behavior of a single teacher model, meaning each student model is limited to learning from a single source of knowledge. This restriction may prevent effective generalization across diverse machine learning tasks, as each new application requires training a separate student model from scratch. Consequently, deploying machine learning models at scale may result in redundant training efforts, increased computational costs, and inconsistencies in learned representations across different tasks. Additionally, if a new machine learning task arises, retraining a model for that task can be time-consuming and computationally expensive. These limitations highlight the need for a more scalable and generalizable machine learning framework that allows knowledge to be transferred across multiple domains while maintaining the ability to specialize for distinct applications.

The present disclosure introduces techniques for training a single student machine learning model using multiple parent machine learning models (also referred to as teacher models) to generate a universal embedding (UE) that can be applied across multiple machine learning tasks. Unlike model distillation techniques, which may involve training a single student model to mimic the behavior of a single teacher model, the present disclosure describes embodiments in which a student model is trained using multiple teacher models. This multi-teacher approach enables the student model to capture shared knowledge across different machine learning domains, allowing for generalization and reusability across different tasks. In this framework, the student model includes universal embedding generation layers (e.g., which may include one or more ResNet layers, fully connected layers, attention layers, etc.). These layers can process raw input data and extracting high-level features to generate a universal embedding (UE), a numerical representation that serves as a common feature space across tasks. During training, input data is provided to both the teacher models and the student model such that the student model’s outputs are refined through parent training layers (e.g., temporary layers that facilitate learning by aligning the student’s predictions with the teacher models’ outputs).

In some aspects, the parent training layers are not retained after training but may serve as an intermediary step to help the student model replicate the behavior of the multiple teacher models. In some embodiments, the training process is performed using a distillation algorithm, which minimizes a loss function to align the outputs of the student model with those of the teacher models. This may ensure that the student model learns to generalize across different domains rather than memorizing individual task-specific patterns. Once training is complete, the parent training layers are discarded, leaving only the trained universal embedding generation layers (e.g., ResNet and fully-connected layers). The trained universal embedding generation layers may then be stored for later retrieval and can be coupled with specialized layers for task-specific applications. This training paradigm solves a fundamental challenge in machine learning where instead of training a new model from scratch for every new task, the present disclosure enables a single trained model (e.g., the universal embedding generation layers) to be reused for multiple specialized tasks. By decoupling the learning of generalized features (e.g., the universal embedding) from task-specific specialization, this approach may improve efficiency, reduce computational costs, and enhance scalability for machine learning applications.

The techniques described herein provide several advantages over other machine learning approaches. By training a single student model using multiple teacher models, the system reduces the need to develop and maintain separate models for different tasks. The universal embedding generation layers enable reusability across multiple applications, reducing redundant training efforts and computational costs. Once trained, these layers can be stored and later retrieved to generate a universal embedding, by coupling these layers with specialized layers to create task-specific machine learning models. This modular framework allows machine learning models to adapt dynamically to new tasks without requiring full retraining. Instead of developing new models from scratch, specialized models can be formed by coupling the trained universal embedding generation layers with specialized layers, optimizing both efficiency and scalability. This approach enhances flexibility for large-scale machine learning systems while maintaining consistency across different applications.

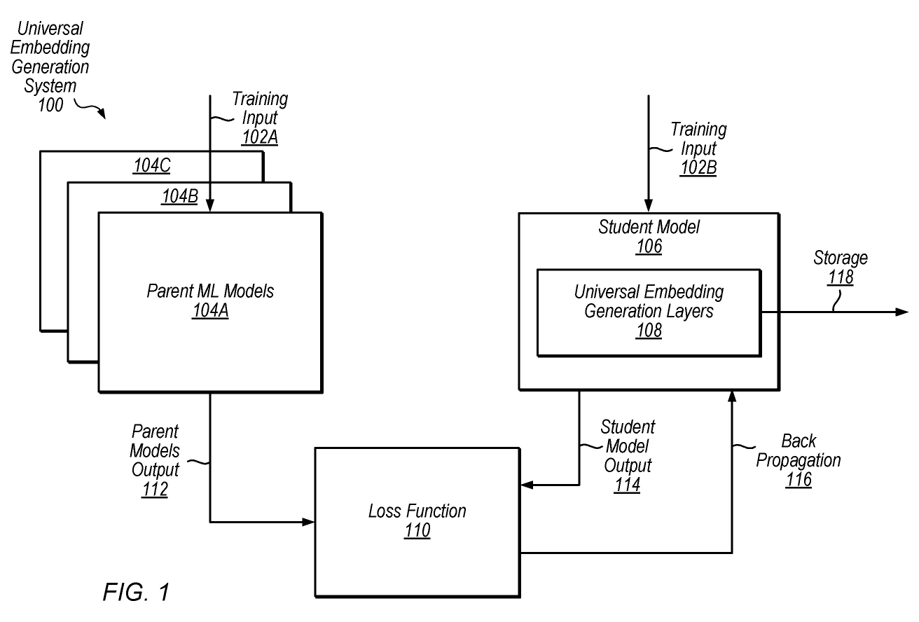

Turning now to FIG. 1, a block diagram of a universal embedding generation system 100 is depicted. In the illustrated embodiment of FIG. 1, universal embedding generation system 100 facilitates the training of a student model 106 using multiple parent ML models 104 to generate a universal embedding that can be utilized across multiple machine learning tasks. By leveraging knowledge distillation, the student model 106 is trained to generalize knowledge from multiple parent ML models 104 rather than just one, which may enhance scalability and efficiency across different domains.

As illustrated in FIG. 1, multiple parent ML models 104 (e.g., 104A, 104B, 104C) receive training input 102A. Each of these parent ML models 104 processes training input 102A according to its own learned parameters and generates a respective parent models output 112. These parent ML models 104 may be pre-trained models specializing in different domains (e.g., fraud detection, identity verification, risk assessment, etc.). Their outputs serve as ground truth references to guide the training of student model 106. While FIG. 1 illustrates three parent ML models 104, it should be understood that any number of parent ML models 104 may be utilized based on implementation needs.

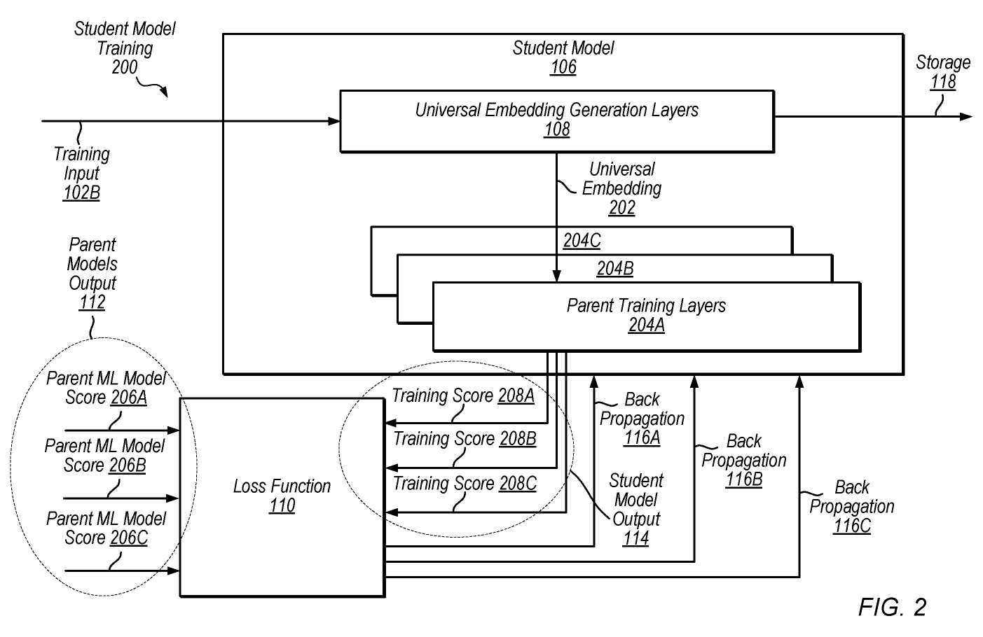

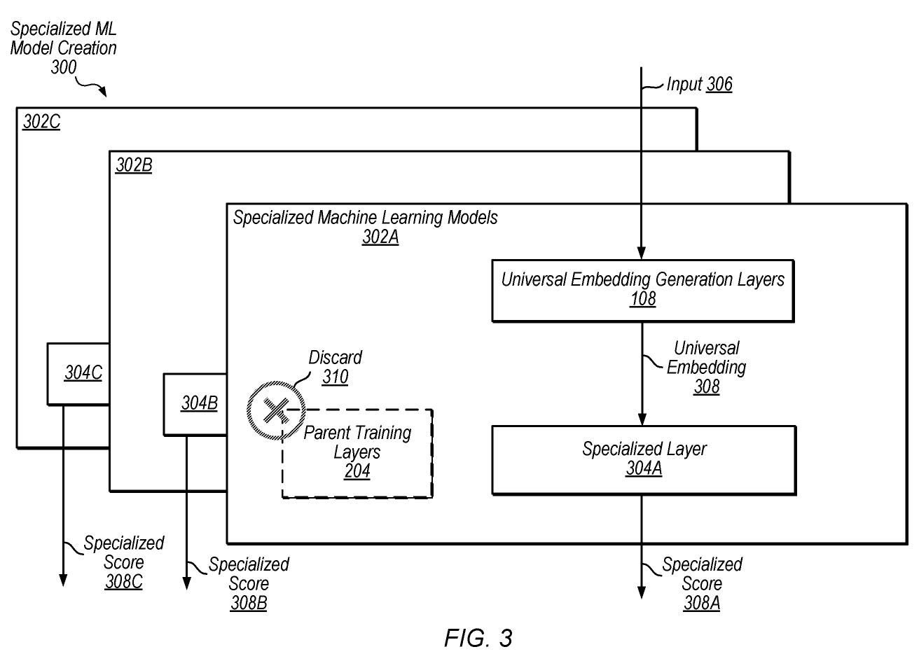

Simultaneously, training input 102B, which in some embodiments is the same (or substantially similar) input data as training input 102A, is also provided to student model 106. Student model 106 comprises universal embedding generation layers 108, which in some embodiments may include ResNet layers, fully connected (FC) layers, attention layers, or other types of neural network layers. These layers (along with additional layers discussed below with FIG. 2.) process training input 102B and generate student model output 114, which, through training, attempts to mimic the outputs of the parent ML models 104.

To ensure student model 106 learns effectively, student model output 114 is compared against parent models output 112 using loss function 110, which determines the difference between the two outputs and generates an error signal used to adjust the parameters of student model 106 via back propagation 116. In various embodiments, examples of loss function 110 implementations may include, but are not limited to, mean squared error (MSE), cross-entropy loss for classification tasks, Kullback-Leibler (KL) divergence loss to measure the difference between probability distributions, and a knowledge distillation (KD) loss function that helps align student model output 114 with the outputs of the parent models 104. Additionally, contrastive loss may be applied to ensure similar inputs generate embeddings that are close in the learned feature space while dissimilar inputs remain farther apart. Those skilled in the art will appreciate additional examples of loss function 110 implementations. By iteratively refining universal embedding generation layers 108, loss function 110 enables student model 106 to generalize across multiple parent ML models 104, ensuring that the learned universal embedding effectively captures knowledge applicable to diverse tasks.

The back propagation 116 updates the universal embedding generation layers 108 by adjusting the weights and biases within the neural network to reduce the loss computed by loss function 110 over successive training iterations. This ensures that universal embedding generation layers 108 gradually learn a shared representation of the input data across different domains. Unlike other training approaches, where student model 106 is trained using only a single teacher model, the embodiment depicted in FIG. 1 enables student model 106 to learn from multiple parent ML models 104, leading to a more generalized and robust feature representation applicable across diverse tasks.

Once the training process is complete, the learned universal embedding generation layers 108 can be stored in storage 118 (e.g., a remote server, a local database, a distributed storage system, computer system, etc.). These stored layers 108 can later be retrieved and coupled to specialized layers for specific downstream applications, thereby forming specialized machine learning models (e.g., which will be discussed in further detail with respect to FIG. 3 below). The ability to decouple the training of universal embedding generation layers 108 from their application in task-specific models increases the reusability of learned knowledge, minimizing the need to retrain models for each new task.

The techniques illustrated in FIG. 1 provide several advantages over conventional methods. First, by training a single student model 106 using multiple parent ML models 104, the universal embedding (e.g., generated by universal embedding generation layers 108) captures shared knowledge across multiple domains. This allows future machine learning models to leverage pre-trained embeddings, improving efficiency and reducing training time. Additionally, by utilizing a loss function 110 to iteratively refine student model 106, the approach ensures that the universal embedding is aligned with the outputs of expert-trained models while retaining flexibility to adapt to new tasks.

In some embodiments, different types of parent ML models 104 may be used for training, depending on task requirements and input data characteristics. For instance, parent ML models 104 may include convolutional neural networks (CNNs), recurrent neural networks (RNNs), transformers, or hybrid architectures, each specializing in different types of pattern recognition, sequential modeling, or contextual learning. Those skilled in the art will recognize that additional variations of parent ML models 104 may be used based on specific application needs.

In summary, FIG. 1 illustrates a universal embedding generation system 100, which trains student model 106 using multiple parent ML models 104. The training process involves providing the same training input 102A, 102B to both parent ML models 104 and student model 106, comparing their respective outputs via loss function 110, and iteratively refining student model 106 through back propagation 116. The result is a trained set of universal embedding generation layers 108, which can be stored in storage 118 for future use in downstream tasks. This framework improves machine learning efficiency, facilitates knowledge transfer across domains, and enables scalable deployment of specialized machine learning models while minimizing redundant retraining efforts.

Turning now to FIG. 2, a block diagram illustrating a student model training process 200 is depicted. In the illustrated embodiment of FIG. 2, student model 106 is shown in greater detail with an emphasis on how training occurs using parent training layers 204 and loss function 110. The training process refines universal embedding generation layers 108, enabling student model 106 to generalize knowledge from multiple parent ML models 104.

During training, student model 106 receives training input 102B, which is processed by universal embedding generation layers 108 to generate universal embedding 202. Universal embedding 202 serves as an intermediate feature representation, encoding high-level abstractions and relationships found in training input 102B. Unlike raw input features, which can be task-specific and vary significantly across different domains, universal embedding 202 provides a generalized, task-agnostic representation that can be leveraged across multiple machine learning tasks. This embedding 202 is learned through universal embedding generation layers 108, which extract meaningful features based on training across multiple parent ML models 104 (e.g., as depicted in FIG. 1). The generated universal embedding 202 is then passed to parent training layers 204, which include 204A, 204B, and 204C. In various embodiments, parent training layers 204 may be implemented as fully connected layers or other types of transformation layers that map universal embedding 202 into a form that aligns with the outputs of parent ML models 104. These layers 204 may act as an intermediary between student model 106 and parent ML models 104, refining student model’s 106 predictions to approximate the reference outputs of the parent ML models 104. In some embodiments, universal embedding 202 may be structured as a dense vector, tensor, or multi-dimensional feature map, depending on the architecture of universal embedding generation layers 108. In some embodiments, universal embedding 202 is a 256-dimensional vector optimized for transaction-related risk assessment, absorbing risk knowledge from raw features through knowledge distillation. Although three parent training layers 204 are illustrated, any number of such layers may be used based on implementation requirements, enabling flexibility in adapting the universal embedding 202 for different learning objectives.

Each parent training layer 204 generates a corresponding training score 208, including training scores 208A, 208B, and 208C (e.g., corresponding to parent training layer 204A, 204B, 204C, respectively), which collectively represent student model output 114 (e.g., as depicted in FIG. 1). These training scores 208 reflect student model’s 106 attempt to approximate the outputs of parent ML models 104. In addition, parent ML models 104 process the same training input 102A and generate parent models output 112, which includes parent ML model scores 206A, 206B, and 206C. These parent ML model scores 206 serve as the ground truth or reference outputs used to guide the learning process of student model 106. The training process iteratively adjusts universal embedding generation layers 108 based on the difference between the training scores 208 and the corresponding parent ML model scores 206, thereby refining universal embedding 202 to capture shared representations across multiple parent ML models 104.

Both training scores 208 (i.e., student model output 114) and parent ML scores 206 (i.e., parent models output 112) serve as inputs to loss function 110, which computes the discrepancy between them and generates a loss value representing the misalignment between student model 106 and parent ML models 104. In various embodiments, loss function 110 may include mean squared error (MSE), cross-entropy loss, Kullback-Leibler (KL) divergence, contrastive loss, or knowledge distillation (KD) loss, depending on the learning objective. The loss function 110 ensures that student model 106 gradually refines its universal embedding generation layers 108 to better align with the outputs of the parent models.

The computed loss value is then used to adjust universal embedding generation layers 108 through back propagation 116, iteratively refining their parameters to minimize the discrepancy. Back propagation 116 updates weights and biases within universal embedding generation layers 108 based on the computed loss. In the illustrated embodiment, back propagation 116A, 116B, and 116C are depicted, corresponding to adjustments made based on each of training scores 208A, 208B, and 208C.

Once training is complete, in some embodiments, parent training layers 204 are no longer used and may be discarded. By contrast, universal embedding generation layers 108, once trained, are retained and stored in storage 118 for later retrieval and reuse. These layers 108 can be coupled with specialized layers, enabling the formation of specialized machine learning models, as will be discussed further in FIG. 3.

In summary, FIG. 2 illustrates the detailed training process of student model 106, where universal embedding generation layers 108 are refined using parent training layers 204 and loss function 110. Training input 102B is processed to generate universal embedding 202, which is then transformed by parent training layers 204 into training scores 208. These scores are compared to parent models output 112, and the resulting loss is used to update universal embedding generation layers 108 via back propagation 116. Once trained, universal embedding generation layers 108 are stored for future use, providing a scalable approach to creating specialized machine learning models without redundant training.

Turning now to FIG. 3, a block diagram illustrating a specialized machine model (ML) creation process 300 is depicted. In the illustrated embodiment of FIG. 3, trained universal embedding generation layers 108, which were previously refined through training (e.g., as discussed in FIG. 2), are now utilized to create multiple specialized machine learning models 302. Each specialized machine learning model 302 includes a respective specialized layer 304 coupled to universal embedding generation layers 108, enabling task-specific predictions while leveraging a shared feature representation.

In some embodiments, input 306 is provided to specialized machine learning model 302A, where it is processed by universal embedding generation layers 108. The output of universal embedding generation layers 108 is universal embedding 308, which serves as an intermediate feature representation passed to specialized layer 304A. Specialized layer 304A refines the embedding and produces specialized score 308A, which represents the final output of specialized machine learning model 302A. This process is similarly applied to specialized machine learning models 302B and 302C, each of which has its own respective specialized layers 304B and 304C, producing outputs specialized scores 308B and 308C, respectively.

In various embodiments, specialized machine learning models 302 may be designed for different applications based on domain-specific requirements. For instance, one specialized model 302A may be optimized for fraud detection in a particular geographic region, ensuring that region-specific transaction patterns are considered when making risk assessments. Another specialized model 302B may be trained for identity verification, where universal embedding 308 is processed to confirm whether an individual matches a known identity profile based on biometric or behavioral data. Similarly, specialized model 302C may be tailored for transaction risk analysis, determining the likelihood of chargebacks or fraudulent activity based on transaction type, merchant category, or payment method. Additional use cases for specialized machine learning models 302 may include, but are not limited to, network security anomaly detection, loan application risk assessment, user activity classification, or recommendation systems where personalized predictions are generated using a universal embedding 308. Those skilled in the art will appreciate additional examples of specialized machine learning models 302.

FIG. 3 depicts parent training layers 204 with a dashed outline and discard indicator 310, indicating that these layers are no longer used after training is complete, unlike in the training phase where they played a crucial role in aligning student model 106 with parent ML models 104. While parent training layers 204 were used for aligning student model 106 with parent ML models 104 during training (as illustrated in FIG. 2), they are used in the model-creation phase, where trained universal embedding generation layers 108 are directly utilized for downstream applications.

In summary, FIG. 3 illustrates how universal embedding generation layers 108 previously trained using multiple parent ML models 104 can be reused across multiple specialized machine learning models 302. Input 306 is processed by universal embedding generation layers 108 to generate universal embedding 308, which is then utilized by specialized layers 304A, 304B, and 304C for task-specific decision-making. The final outputs, specialized scores 308A, 308B, and 308C, reflect predictions tailored to different applications. This framework enables knowledge transfer across machine learning tasks, facilitates model specialization without redundant retraining, and improves the scalability of machine learning deployment across various domains.

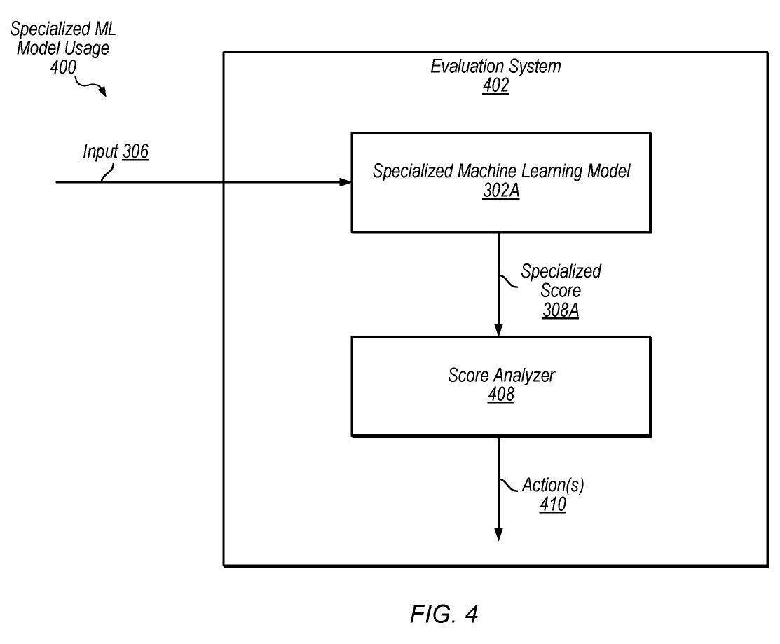

Turning now to FIG. 4, a block diagram illustrating specialized machine model usage 400 is depicted. In the illustrated embodiment of FIG. 4, evaluation system 402 is shown leveraging specialized machine learning model 302A to process input 306 and generate specialized score 308A, which is subsequently analyzed to determine an appropriate action 410. FIG. 4 illustrates how specialized machine learning models 302 may be applied to real-world decision-making processes.

Input 306 is provided to specialized machine learning model 302A, which processes the input using trained universal embedding generation layers 108 (not illustrated in FIG. 4 but described in FIG. 3). The output of specialized machine learning model 302A is specialized score 308A, which represents the model’s 302A evaluation of input 306 data based on task-specific criteria. This score 308A is then provided to score analyzer 408, which determines an appropriate action 410 based on predefined decision-making logic.

In various embodiments, specialized score 308A may correspond to different types of predictive outputs depending on the application of specialized machine learning model 302A. For instance, in a fraud detection system, specialized score 308A may represent a fraud risk probability, with score analyzer 408 applying a threshold to determine whether to approve or decline a transaction. If the fraud risk score exceeds a predetermined threshold, score analyzer 408 may initiate an action declining the transaction; otherwise, the transaction may be approved.

In another example, specialized machine learning model 302A may be applied to identity verification, where input 306 represents a user’s biometric data or behavioral characteristics. Specialized score 308A in this case may indicate a confidence level in matching input 306 data to a known identity. Score analyzer 408 may then determine whether the confidence level meets a required security threshold, and based on that, action 410 may involve granting or denying system access.

Additionally, in transaction risk analysis, specialized score 308A may represent a chargeback likelihood based on the merchant type, payment method, and historical transaction patterns. In this case, score analyzer 408 may classify the transaction risk and take action 410, such as flagging the transaction for manual review, applying additional authentication measures, or rejecting high-risk payments. Other potential applications of specialized machine learning model 302A may include network security anomaly detection, where specialized score 308A indicates whether incoming traffic resembles known cyber threats, and action 410 involves blocking the connection or alerting security teams. In the context of loan application risk assessment, specialized score 308A may predict the probability of default, and action 410 may involve approving, denying, or requesting additional documentation for the application. In user activity classification, specialized score 308A may categorize user behavior based on engagement patterns, and action 410 may involve triggering personalized content recommendations, issuing security alerts, or imposing access restrictions. In an e-commerce recommendation system, specialized score 308A may determine product relevance based on user browsing and purchase history, and action 410 may involve displaying targeted advertisements or prioritizing search results. In medical diagnostics, specialized score 308A may indicate the likelihood of a certain condition based on patient data, and action 410 may involve recommending further tests or alerting healthcare providers. Those skilled in the art will recognize additional use cases where specialized machine learning models 302 can generate predictive scores that guide automated decision-making processes.

In summary, FIG. 4 illustrates how specialized machine learning model 302A is deployed within evaluation system 402 to process input 306, generate a specialized score 308A, and apply decision-making logic via score analyzer 408 to determine an appropriate action 410. By leveraging previously trained universal embedding generation layers 108, specialized machine learning models enable real-time decision-making across a variety of domains without requiring extensive retraining for each individual task.

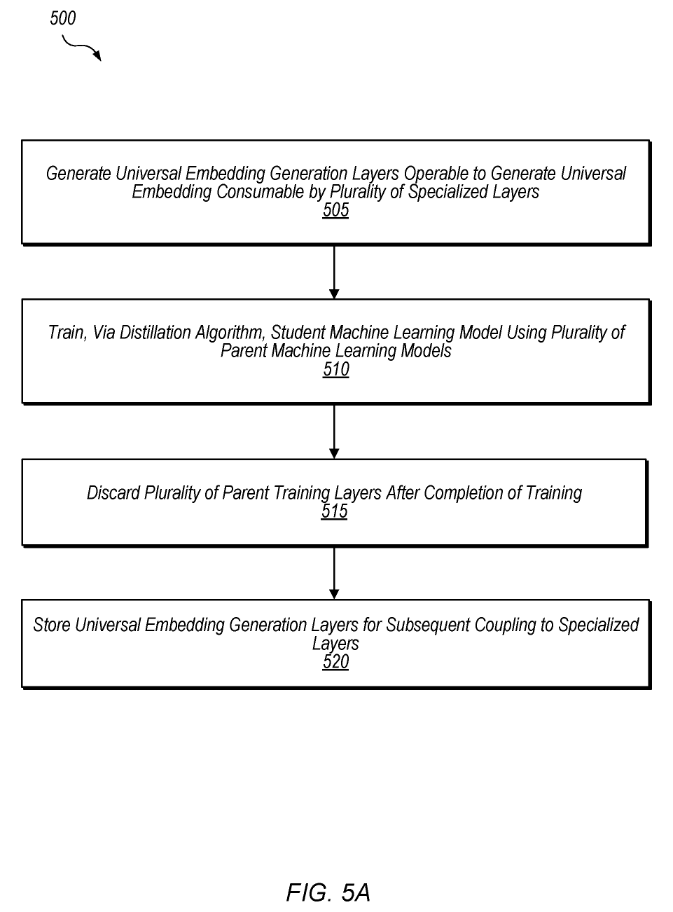

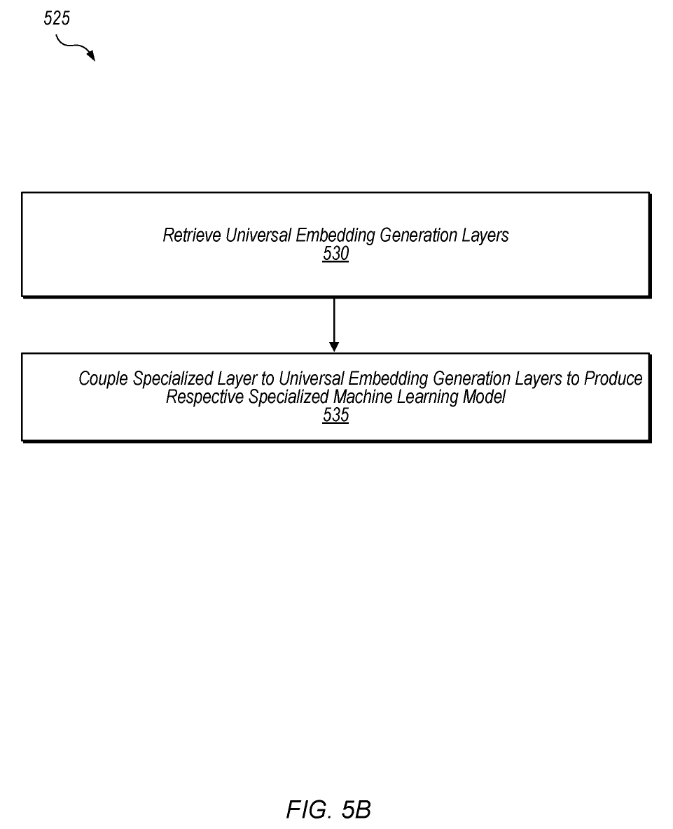

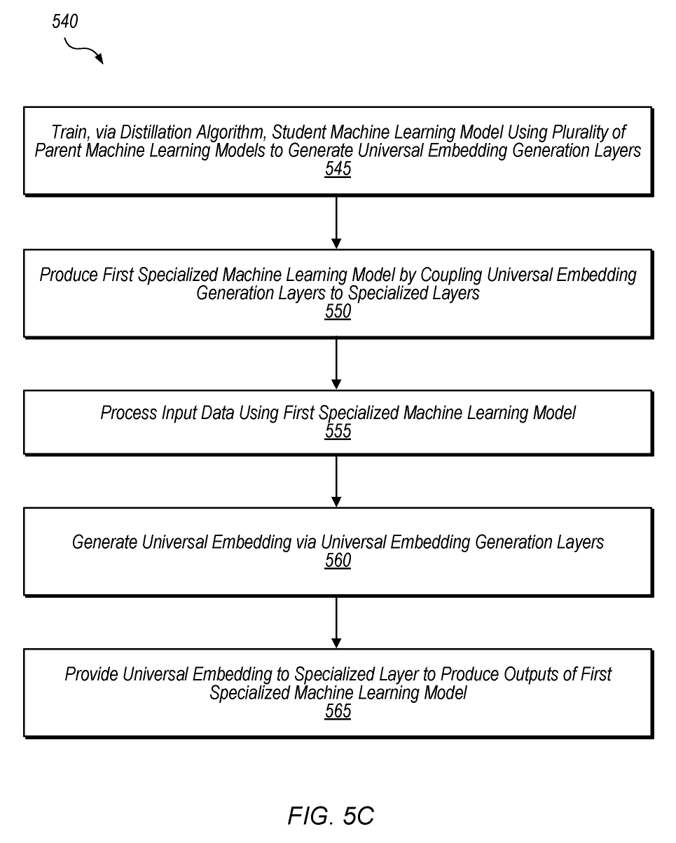

Turning now to FIG. 5A, a flow diagram of a method 500 is shown. Method 500 is one embodiment of a method performed by a computer system (e.g., computing system 600). Method 500 may be performed by executing a set of program instructions stored on a non-transitory computer-readable medium.

Method 500 begins in step 505 with the computer system generating universal embedding generation layers operable to generate a universal embedding consumable by a plurality of specialized layers, each couplable to the universal embedding generation layers to produce a respective specialized machine learning model. For example, as illustrated in FIG. 3, universal embedding generation layers 108, previously trained via student model 106, may be coupled to specialized layers 304A, 304B, and 304C to create specialized machine learning models 302A, 302B, and 302C. These specialized machine learning models 302 utilize universal embedding 308 as an intermediate feature representation, allowing them to perform task-specific predictions while leveraging a shared embedding space across different applications.

In step 510, generating the universal embedding generation layers includes training, via a distillation algorithm, a student machine learning model using a plurality of parent machine learning models, wherein the student machine learning model includes the universal embedding generation layers coupled to a plurality of parent training layers. For example, as illustrated in FIG. 2, student model 106 is trained using multiple parent ML models 104A, 104B, and 104C, which serve as teacher models to guide the learning process. During training, universal embedding generation layers 108 generate universal embedding 202, which is processed by parent training layers 204A, 204B, and 204C to produce training scores 208A, 208B, and 208C. These scores are compared against parent model scores 206A, 206B, and 206C using loss function 110 to iteratively refine the parameters of universal embedding generation layers 108 through back propagation 116. In some examples, the plurality of parent training layers are used to facilitate training with respect to the plurality of parent machine learning models. For example, as illustrated in FIG. 2, parent training layers 204A, 204B, and 204C act as intermediary layers that map universal embedding 202 into a form that aligns with the outputs of parent ML models 104A, 104B, and 104C, such that student model 106 learns to approximate the reference outputs of the parent ML models during training.

In step 515, generating the universal embedding generation layers includes discarding the plurality of parent training layers after completion of the training. For example, as illustrated in FIG. 2, once student model 106 has been trained using parent training layers 204A, 204B, and 204C to align with the outputs of parent ML models 104, these parent training layers 204 are no longer needed. As shown in FIG. 3, parent training layers 204 are depicted with a dashed outline and a discard indicator 310, signifying that they are discarded after training is complete, leaving only the trained universal embedding generation layers 108, which are retained for future use.

In step 520, the computer system stores the universal embedding generation layers for subsequent coupling to one or more of the plurality of specialized layers. For example, as illustrated in FIG. 2, once training is complete, the trained universal embedding generation layers 108 are retained and stored in storage 118 for later use. As shown in FIG. 3, these stored universal embedding generation layers 108 can be subsequently accessed and coupled to one or more specialized layers 304 to form specialized machine learning models 302, enabling task-specific adaptations without retraining the entire model.

In some embodiments, the training includes providing input data to the student machine learning model to cause the universal embedding generation layers to generate a universal embedding from the input data and one of the parent training layers to generate student output data based on the universal embedding and comparing the student output data to parent output data generated by one of the parent machine learning models based on the input data. For example, as illustrated in FIG. 2, training input 102B is provided to student model 106, which processes the input through universal embedding generation layers 108 to generate universal embedding 202. This universal embedding 202 is then passed to parent training layers 204A, 204B, and 204C, which produce training scores 208A, 208B, and 208C. Simultaneously, the same training input 102A is processed by parent ML models 104A, 104B, and 104C, which generate corresponding parent model scores 206A, 206B, and 206C. Loss function 110 compares training scores 208 to parent model scores 206, computing an error signal that is used to refine universal embedding generation layers 108 through back propagation 116, thereby ensuring that student model 106 learns to align with the outputs of the parent ML models 104.

In some embodiments, the comparing includes applying a loss function to the student output data and the parent output data and the training further includes performing, based on a result of the loss function, backpropagation via the one of the parent training layers and the universal embedding generation layers. For example, as illustrated in FIG. 2, loss function 110 computes the difference between training scores 208A, 208B, and 208C (i.e., student model output 114) and parent model scores 206A, 206B, and 206C (i.e., parent models output 112). The computed loss value represents the misalignment between student model 106 and parent ML models 104. Based on this result, back propagation 116A, 116B, and 116C are performed, iteratively adjusting the parameters of universal embedding generation layers 108 and parent training layers 204A, 204B, and 204C to refine universal embedding 202. This iterative training process may ensure that student model 106 effectively learns to approximate the outputs of the parent ML models while improving generalization across multiple machine learning domains.

In some embodiments, method 500 further includes the computer system generating a first specialized machine learning model by coupling the universal embedding to one of the specialized layers. For example, as illustrated in FIG. 3, a first specialized machine learning model 302A may be generated by coupling trained universal embedding generation layers 108 to specialized layer 304A, enabling task-specific predictions based on input 306. In some embodiments, the first specialized machine learning model is operable to determine whether an action can be performed based on an input request, wherein the determination includes assessing a risk associated with performing the action. For example, evaluation system 402 may utilize specialized machine learning model 302A to process input 306 and generate specialized score 308A, which is then analyzed by score analyzer 408 to assess a risk associated with performing an action 410. Based on the analysis, score analyzer 408 may determine whether action 410 should be taken.

In some embodiments, the first specialized machine learning model is operable to perform fraud detection, identity verification, anomaly detection, or a combination thereof. For example, specialized machine learning model 302A may be configured for fraud detection by analyzing transaction data patterns to assess risk, while specialized machine learning model 302B may be configured for identity verification by evaluating biometric or behavioral data. Similarly, another specialized machine learning model 302C may be designed for anomaly detection by identifying deviations from expected patterns in network traffic or user activity. Each specialized machine learning model 302 leverages universal embedding generation layers 108 while applying task-specific transformations via its respective specialized layer 304 to generate specialized scores for decision-making. In some embodiments, method 500 further includes the computer system generating a second specialized machine learning model by coupling the universal embedding to another of the specialized layers, wherein the second specialized machine learning model is operable to perform a different machine learning task than the first specialized machine learning model. For example, universal embedding generation layers 108 may be coupled to different specialized layers 304 to create multiple specialized machine learning models 302. A first specialized machine learning model 302A may be configured for fraud detection, while a second specialized machine learning model 302B may be configured for identity verification. Each specialized machine learning model 302 leverages the shared universal embedding 108 while applying task-specific transformations via its respective specialized layer 304, enabling the models to perform distinct machine learning tasks.

In some embodiments, the universal embedding generation layers include one or more ResNet layers and one or more fully connected neural network layers. For example, as illustrated in FIG. 1, universal embedding generation layers 108 may include one or more ResNet layers and fully connected neural network layers, which process training input 102B to generate universal embedding 202. In some embodiments, the universal embedding generation layers include one or more attention layers. For example, as illustrated in FIG. 1, universal embedding generation layers 108 may include one or more attention layers.

Turning now to FIG. 5B, a flow diagram of a method 525 is shown. Method 525 is one embodiment of a method performed by a computer system (e.g., computing system 600) and may be performed by executing a set of program instructions stored on a non-transitory computer-readable medium.

Method 525 begins in step 530, with the computer system retrieving universal embedding generation layers, wherein the universal embedding generation layers are generated by training a student machine learning model using a plurality of parent machine learning models. For example, student model 106 is trained using multiple parent ML models 104, refining universal embedding generation layers 108 through parent training layers 204 and loss function 110. Once training is complete, universal embedding generation layers 108 are stored in storage 118.

In step 535, the computer system couples a specialized layer to the universal embedding generation layers to produce a first specialized machine learning model. For example, specialized layer 304 (e.g., specialized layer 304A, 304B, or 304C) is coupled to universal embedding generation layers 108 to form a specialized machine learning model 302 (e.g., specialized model 302A, 302B, or 302C). This coupling enables the specialized machine learning model to leverage the generalized feature representations encoded in universal embedding generation layers 108 while adapting to specific tasks through the specialized layer 304.

In some embodiments, method 525 further includes using the first specialized machine learning model to process input data for a machine learning task, wherein the using includes generating a universal embedding by providing the input data to the universal embedding generation layers and providing the universal embedding to the coupled specialized layer to produce an output of the specialized machine learning model. For example, evaluation system 402 processes input 306 using specialized machine learning model 302A. The input 306 is first processed by universal embedding generation layers 108 to generate a universal embedding 308, which is then provided to specialized layer 304A. Specialized layer 304A further refines the embedding and generates specialized score 308A, which represents the final output of specialized machine learning model 302A.

In some embodiments, method 525 further includes evaluating the produced output against a predetermined threshold to determine whether to perform a particular action and causing performance of the particular action based on the evaluating. For example, as illustrated in FIG. 4, specialized score 308A, generated by specialized machine learning model 302A, is analyzed by score analyzer 408 to determine whether the score meets or exceeds a predetermined threshold. Based on this evaluation, action 410 may be performed or prevented. For instance, in a fraud detection system, if specialized score 308A indicates a high likelihood of fraudulent activity, score analyzer 408 may initiate an action preventing a transaction. Conversely, if specialized score 308A is below the threshold, action 410 may allow the transaction to proceed. Similar decision-making processes may be applied in identity verification, anomaly detection, or risk assessment tasks, where specialized score 308A guides automated actions based on domain-specific criteria. In some embodiments, method 525 further includes the computer system producing a second, different specialized machine learning model by coupling another specialized layer to the universal embedding generation layers. For example, as illustrated in FIG. 3, a second specialized layer 304B may be coupled to universal embedding generation layers 108 to form a second specialized machine learning model 302B. This second specialized machine learning model 302B may be designed for a different task than the first specialized machine learning model 302A. For instance, while specialized model 302A may be optimized for fraud detection, specialized model 302B may be trained for identity verification, utilizing the same universal embedding 308 but applying a distinct specialized layer 304B to refine task-specific predictions.

In some embodiments, the universal embedding generation layers include a convolutional neural network layer, a ResNet layer, an attention-based layer, or a combination thereof. For example, universal embedding generation layers 108 may include ResNet layers for feature extraction, attention-based layers for contextual weighting, or convolutional neural network layers for spatial pattern recognition, depending on the machine learning task.

Turning now to FIG. 5C, a flow diagram of a method 540 is shown. Method 540 is one embodiment of a method performed by a computer system (e.g., computing system 600) and may be performed by executing a set of program instructions stored on a non-transitory computer-readable medium.

Method 540 begins in step 545 with the computer system training, via a distillation algorithm, a student machine learning model using a plurality of parent machine learning models to generate universal embedding generation layers. For example, student model 106 is trained using multiple parent ML models 104, with parent training layers 204 facilitating alignment between the student model’s predictions and the outputs of the parent models. During training, loss function 110 computes discrepancies between student model output 114 and parent model scores 206, refining universal embedding generation layers 108 through back propagation 116 to generalize across different tasks.

In step 550, the computer system produces a first specialized machine learning model by coupling the universal embedding generation layers to one or more specialized layers. For example, as illustrated in FIG. 3, universal embedding generation layers 108, after being retrieved from storage 118, may be coupled to specialized layer 304A to form specialized machine learning model 302A. This configuration enables specialized machine learning model 302A to utilize the learned universal embedding 308 while applying task-specific transformations through specialized layer 304A, producing a specialized score 308A. This approach allows the specialized machine learning model to perform domain-specific tasks while benefiting from the generalized feature representations encoded in universal embedding generation layers 108.

In step 555, the computer system processes input data using the first specialized machine learning model. For example, as illustrated in FIG. 3, input 306 is provided to specialized machine learning model 302A, where it is processed by universal embedding generation layers 108. The generated universal embedding 308 is then passed to specialized layer 304A, which refines the embedding and produces specialized score 308A as an output of specialized machine learning model 302A. This process enables specialized machine learning model 302A to leverage the shared feature representation from universal embedding generation layers 108 while adapting to task-specific predictions.

In step 560, processing includes generating a universal embedding via the universal embedding generation layers. For example, as illustrated in FIG. 3, input 306 is processed by universal embedding generation layers 108 to generate universal embedding 308, which serves as an intermediate feature representation. This embedding captures high-level abstractions from the input data, allowing it to be leveraged across different specialized machine learning models 302A, 302B, and 302C for task-specific predictions.

In step 565, processing includes providing the universal embedding to the one or more specialized layer to produce one or more outputs of the first specialized machine learning model. For example, as illustrated in FIG. 3, universal embedding 308 is provided to specialized layer 304A of specialized machine learning model 302A. Specialized layer 304A processes the universal embedding to generate a specialized score 308A, which represents the model’s output for the task at hand, such as fraud detection, identity verification, or another domain-specific application.

### Exemplary Computer System

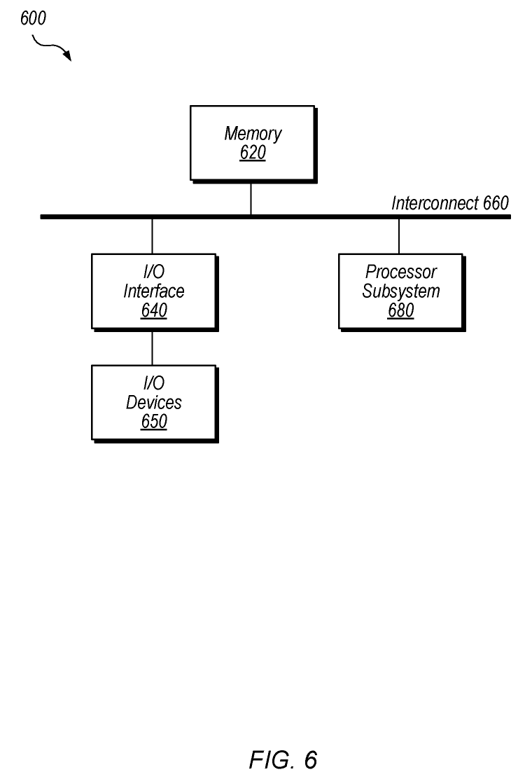

Turning now to FIG. 6, a block diagram of an exemplary computer system 600 is depicted, which may implement universal embedding generation system 100, student model training 200, specialized ML model creation 300, and specialized ML model usage 400. Computer system 600 includes a processor subsystem 680 that is coupled to a system memory 620 and I/O interfaces(s) 640 via an interconnect 660 (e.g., a system bus). I/O interface(s) 640 is coupled to one or more I/O devices 650. Although a single computer system 600 is shown in FIG. 6 for convenience, system 600 may also be implemented as two or more computer systems operating together.

Processor subsystem 680 may include one or more processors or processing units. In various embodiments of computer system 600, multiple instances of processor subsystem 680 may be coupled to interconnect 660. In various embodiments, processor subsystem 680 (or each processor unit within 680) may contain a cache or other form of on-board memory.

System memory 620 is usable store program instructions executable by processor subsystem 680 to cause system 600 perform various operations described herein. System memory 620 may be implemented using different physical memory media, such as hard disk storage, floppy disk storage, removable disk storage, flash memory, random access memory (RAM—SRAM, EDO RAM, SDRAM, DDR SDRAM, RAMBUS RAM, etc.), read only memory (PROM, EEPROM, etc.), and so on. Memory in computer system 600 is not limited to primary storage such as memory 620. Rather, computer system 600 may also include other forms of storage such as cache memory in processor subsystem 680 and secondary storage on I/O Devices 650 (e.g., a hard drive, storage array, etc.). In some embodiments, these other forms of storage may also store program instructions executable by processor subsystem 680. In some embodiments, program instructions that when executed implement elements of system 100 may be included/stored within system memory 620.

I/O interfaces 640 may be any of various types of interfaces configured to couple to and communicate with other devices, according to various embodiments. In one embodiment, I/O interface 640 is a bridge chip (e.g., Southbridge) from a front-side to one or more back-side buses. I/O interfaces 640 may be coupled to one or more I/O devices 650 via one or more corresponding buses or other interfaces. Examples of I/O devices 650 include storage devices (hard drive, optical drive, removable flash drive, storage array, SAN, or their associated controller), network interface devices (e.g., to a local or wide-area network), or other devices (e.g., graphics, user interface devices, etc.). In one embodiment, computer system 600 is coupled to a network via a network interface device 650 (e.g., configured to communicate over Wi-Fi^{®}, Bluetooth^{®}, Ethernet, etc.).

The present disclosure includes references to “embodiments,” which are non-limiting implementations of the disclosed concepts. References to “an embodiment,” “one embodiment,” “a particular embodiment,” “some embodiments,” “various embodiments,” and the like do not necessarily refer to the same embodiment. A large number of possible embodiments are contemplated, including specific embodiments described in detail, as well as modifications or alternatives that fall within the spirit or scope of the disclosure. Not all embodiments will necessarily manifest any or all of the potential advantages described herein.

This disclosure may discuss potential advantages that may arise from the disclosed embodiments. Not all implementations of these embodiments will necessarily manifest any or all of the potential advantages. Whether an advantage is realized for a particular implementation depends on many factors, some of which are outside the scope of this disclosure. In fact, there are a number of reasons why an implementation that falls within the scope of the claims might not exhibit some or all of any disclosed advantages. For example, a particular implementation might include other circuitry outside the scope of the disclosure that, in conjunction with one of the disclosed embodiments, negates or diminishes one or more the disclosed advantages. Furthermore, suboptimal design execution of a particular implementation (e.g., implementation techniques or tools) could also negate or diminish disclosed advantages. Even assuming a skilled implementation, realization of advantages may still depend upon other factors such as the environmental circumstances in which the implementation is deployed. For example, inputs supplied to a particular implementation may prevent one or more problems addressed in this disclosure from arising on a particular occasion, with the result that the benefit of its solution may not be realized. Given the existence of possible factors external to this disclosure, it is expressly intended that any potential advantages described herein are not to be construed as claim limitations that must be met to demonstrate infringement. Rather, identification of such potential advantages is intended to illustrate the type(s) of improvement available to designers having the benefit of this disclosure. That such advantages are described permissively (e.g., stating that a particular advantage “may arise”) is not intended to convey doubt about whether such advantages can in fact be realized, but rather to recognize the technical reality that realization of such advantages often depends on additional factors.

Unless stated otherwise, embodiments are non-limiting. That is, the disclosed embodiments are not intended to limit the scope of claims that are drafted based on this disclosure, even where only a single example is described with respect to a particular feature. The disclosed embodiments are intended to be illustrative rather than restrictive, absent any statements in the disclosure to the contrary. The application is thus intended to permit claims covering disclosed embodiments, as well as such alternatives, modifications, and equivalents that would be apparent to a person skilled in the art having the benefit of this disclosure.

For example, features in this application may be combined in any suitable manner. Accordingly, new claims may be formulated during prosecution of this application (or an application claiming priority thereto) to any such combination of features. In particular, with reference to the appended claims, features from dependent claims may be combined with those of other dependent claims where appropriate, including claims that depend from other independent claims. Similarly, features from respective independent claims may be combined where appropriate.

Accordingly, while the appended dependent claims may be drafted such that each depends on a single other claim, additional dependencies are also contemplated. Any combinations of features in the dependent that are consistent with this disclosure are contemplated and may be claimed in this or another application. In short, combinations are not limited to those specifically enumerated in the appended claims.

Where appropriate, it is also contemplated that claims drafted in one format or statutory type (e.g., apparatus) are intended to support corresponding claims of another format or statutory type (e.g., method).

Because this disclosure is a legal document, various terms and phrases may be subject to administrative and judicial interpretation. Public notice is hereby given that the following paragraphs, as well as definitions provided throughout the disclosure, are to be used in determining how to interpret claims that are drafted based on this disclosure.

References to a singular form of an item (i.e., a noun or noun phrase preceded by “a,” “an,” or “the”) are, unless context clearly dictates otherwise, intended to mean “one or more.” Reference to “an item” in a claim thus does not, without accompanying context, preclude additional instances of the item. A “plurality” of items refers to a set of two or more of the items.

The word “may” is used herein in a permissive sense (i.e., having the potential to, being able to) and not in a mandatory sense (i.e., must).

The terms “comprising” and “including,” and forms thereof, are open-ended and mean “including, but not limited to.”

When the term “or” is used in this disclosure with respect to a list of options, it will generally be understood to be used in the inclusive sense unless the context provides otherwise. Thus, a recitation of “x or y” is equivalent to “x or y, or both,” and thus covers 1) x but not y, 2) y but not x, and 3) both x and y. On the other hand, a phrase such as “either x or y, but not both” makes clear that “or” is being used in the exclusive sense.

A recitation of “w, x, y, or z, or any combination thereof” or “at least one of … w, x, y, and z” is intended to cover all possibilities involving a single element up to the total number of elements in the set. For example, given the set [w, x, y, z], these phrasings cover any single element of the set (e.g., w but not x, y, or z), any two elements (e.g., w and x, but not y or z), any three elements (e.g., w, x, and y, but not z), and all four elements. The phrase “at least one of … w, x, y, and z” thus refers to at least one element of the set [w, x, y, z], thereby covering all possible combinations in this list of elements. This phrase is not to be interpreted to require that there is at least one instance of w, at least one instance of x, at least one instance of y, and at least one instance of z.

Various “labels” may precede nouns or noun phrases in this disclosure. Unless context provides otherwise, different labels used for a feature (e.g., “first circuit,” “second circuit,” “particular circuit,” “given circuit,” etc.) refer to different instances of the feature. Additionally, the labels “first,” “second,” and “third” when applied to a feature do not imply any type of ordering (e.g., spatial, temporal, logical, etc.), unless stated otherwise.

The phrase “based on” or is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor that is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

The phrases “in response to” and “responsive to” describe one or more factors that trigger an effect. This phrase does not foreclose the possibility that additional factors may affect or otherwise trigger the effect, either jointly with the specified factors or independent from the specified factors. That is, an effect may be solely in response to those factors, or may be in response to the specified factors as well as other, unspecified factors. Consider the phrase “perform A in response to B.” This phrase specifies that B is a factor that triggers the performance of A, or that triggers a particular result for A. This phrase does not foreclose that performing A may also be in response to some other factor, such as C. This phrase also does not foreclose that performing A may be jointly in response to B and C. This phrase is also intended to cover an embodiment in which A is performed solely in response to B. As used herein, the phrase “responsive to” is synonymous with the phrase “responsive at least in part to.” Similarly, the phrase “in response to” is synonymous with the phrase “at least in part in response to.”

Within this disclosure, different entities (which may variously be referred to as “units,” “circuits,” other components, etc.) may be described or claimed as “configured” to perform one or more tasks or operations. This formulation—[entity] configured to [perform one or more tasks]—is used herein to refer to structure (i.e., something physical). More specifically, this formulation is used to indicate that this structure is arranged to perform the one or more tasks during operation. A structure can be said to be “configured to” perform some task even if the structure is not currently being operated. Thus, an entity described or recited as being “configured to” perform some task refers to something physical, such as a device, circuit, a system having a processor unit and a memory storing program instructions executable to implement the task, etc. This phrase is not used herein to refer to something intangible.

In some cases, various units/circuits/components may be described herein as performing a set of task or operations. It is understood that those entities are “configured to” perform those tasks/operations, even if not specifically noted.

The term “configured to” is not intended to mean “configurable to.” An unprogrammed FPGA, for example, would not be considered to be “configured to” perform a particular function. This unprogrammed FPGA may be “configurable to” perform that function, however. After appropriate programming, the FPGA may then be said to be “configured to” perform the particular function.

For purposes of United States patent applications based on this disclosure, reciting in a claim that a structure is “configured to” perform one or more tasks is expressly intended not to invoke 35 U.S.C. § 112(f) for that claim element. Should Applicant wish to invoke Section 112(f) during prosecution of a United States patent application based on this disclosure, it will recite claim elements using the “means for” [performing a function] construct.

What is claimed is:

1. A computer-implemented method, comprising:
generating universal embedding generation layers operable to generate a universal embedding consumable by a plurality of specialized layers, each couplable to the universal embedding generation layers to produce a respective specialized machine learning model, wherein the generating includes:
training, via a distillation algorithm, a student machine learning model using a plurality of parent machine learning models, wherein the student machine learning model includes the universal embedding generation layers coupled to a plurality of parent training layers, wherein the plurality of parent training layers are used to facilitate training with respect to the plurality of parent machine learning models; and
discarding the plurality of parent training layers after completion of the training; and
storing the universal embedding generation layers for subsequent coupling to one or more of the plurality of specialized layers.

2. The method of claim 1, wherein the training includes:
providing input data to the student machine learning model to cause:
the universal embedding generation layers to generate a universal embedding from the input data; and
one of the parent training layers to generate student output data based on the universal embedding; and
comparing the student output data to parent output data generated by one of the parent machine learning models based on the input data.

3. The method of claim 2, wherein the comparing includes applying a loss function to the student output data and the parent output data; and
wherein the training further includes performing, based on a result of the loss function, backpropagation via the one of the parent training layers and the universal embedding generation layers.

4. The method of claim 1, further comprising:
generating a first specialized machine learning model by coupling the stored universal embedding generation layers to one of the specialized layers.

5. The method of claim 4, wherein the first specialized machine learning model is operable to determine whether an action can be performed based on an input request, wherein the determination includes assessing a risk associated with performing the action.

6. The method of claim 5, wherein the first specialized machine learning model is operable to perform fraud detection, identity verification, anomaly detection, or a combination thereof.

7. The method of claim 4, further comprising:
generating a second specialized machine learning model by coupling the universal embedding generation layers to another of the specialized layers, wherein the second specialized machine learning model is operable to perform a different machine learning task than a tasked performed by the first specialized machine learning model.

8. The method of claim 1, wherein the universal embedding generation layers include one or more ResNet layers and one or more fully connected neural network layers.

9. The method of claim 1, wherein the universal embedding generation layers include one or more attention layers.

10. A computer-implemented method, comprising:
retrieving universal embedding generation layers, wherein the universal embedding generation layers are generated by training a student machine learning model using a plurality of parent machine learning models; and
coupling a specialized layer to the universal embedding generation layers to produce a first specialized machine learning model.

11. The method of claim 10, further comprising:
using the first specialized machine learning model to process input data for a machine learning task, wherein the using includes:
generating a universal embedding by providing the input data to the universal embedding generation layers; and
providing the universal embedding to the coupled specialized layer to produce an output of the specialized machine learning model.

12. The method of claim 11, further comprising:
evaluating the produced output against a predetermined threshold to determine whether to perform a particular action; and
causing performance of the particular action based on the evaluating.

13. The method of claim 10, further comprising:
producing a second, different specialized machine learning model by coupling another specialized layer to the universal embedding generation layers.

14. The method of claim 10, wherein the universal embedding generation layers include a convolutional neural network layer, a ResNet layer, an attention-based layer, or a combination thereof.

15. A non-transitory computer-readable medium having program instructions stored thereon that are capable of causing a computer system to perform operations comprising:
training, via a distillation algorithm, a student machine learning model using a plurality of parent machine learning models to generate universal embedding generation layers;
producing a first specialized machine learning model by coupling the universal embedding generation layers to one or more specialized layers;
processing input data using the first specialized machine learning model, wherein the processing includes:
generating a universal embedding via the universal embedding generation layers; and
providing the universal embedding to the one or more specialized layer to produce one or more outputs of the first specialized machine learning model.

16. The non-transitory computer-readable medium of claim 15, wherein the training includes:
providing training input data to the student machine learning model to cause the universal embedding generation layers to generate a training universal embedding;
generating student output data using one of a plurality of parent training layers operable to consume the training universal embedding and coupled to the universal embedding generation layers; and
comparing the student output data to parent output data generated by one of the parent machine learning models based on the input data.

17. The non-transitory computer-readable medium of claim 16, wherein the training further includes:
performing, based the comparing, backpropagation via the one of the parent training layers and the universal embedding generation layers.

18. The non-transitory computer-readable medium of claim 16, wherein the operations further comprising:
discarding the plurality of parent training layers after completion of the training.

19. The non-transitory computer-readable medium of claim 15, wherein the operations further comprising:
producing a second specialized machine learning model by coupling the universal embedding to another one or more specialized layers, wherein the second specialized machine learning model is operable to perform a machine learning task that differs from tasks performed by the first specialized machine learning model.

20. The non-transitory computer-readable medium of claim 15, wherein the universal embedding generation layers include at least one of a convolutional neural network layer, a ResNet layer, an attention-based layer, or a combination thereof.
